(19) United States
(12) Patent Application Publication
(10) Pub. No.: US 2007/0013642 A1
(43) Pub. Date: Jan. 18, 2007

(54) System for transferring flat panel display substrates during manufacture

(75) Inventors: Gi-Cheon Yoon, Gyeonggi-do (KR); Hwan-Gerl Hwang, Gyeonggi-do (KR); Yoo-Seok Kim, Gyeonggi-do (KR); Jin-Gi Kim, Gyeonggi-do (KR); In-Ho Lee, Gyeonggi-do (KR); Hyung Lee, Gyeonggi-do (KR); Sung-Il Jung, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/486,795

(22) Filed: Jul. 13, 2006

(30) Foreign Application Priority Data
Jul. 13, 2005 (KR) 10-2005-0063233

(51) Int. Cl. G09G 3/36

(52) U.S. Cl. 345/100

(57) ABSTRACT

A system is provided for transferring a substrate of a flat panel display between the processing stations of a flat panel display manufacturing line. The system includes a transfer device that transfers a transfer container in which a substrate is loaded, a container loading and unloading device that loads and unloads the containers on and from the transfer device, and a substrate loading and unloading device that transfers the substrates between the container and processing equipment located at the respective stations. The transfer device includes a track mounted on a facility floor and a plurality of wheeled carriages that move programmably along the track by means of linear motors. The system enables substrate transfer time to be reduced substantially, yet provides robust protection of the substrates throughout the transfer process.

### RELATED APPLICATIONS

This application claims priority under 35 U.S.C. § 119 of Korean Patent Application No. 2005-0063233, filed Jul. 13, 2005, the disclosure of which is incorporated herein by reference in its entirety.

### BACKGROUND

(1) Field of the Invention

The present invention relates to a system for automatically transferring substrates of flat panel displays between the processing stations of a flat panel display manufacturing line.

(2) Description of the Related Art

Currently, flat panel displays, such as liquid crystal displays (“LCDs”), organic light emitting diode displays and the like, are used in a wide variety of display applications.

A flat panel display is produced by conveying a glass substrate to processing equipment located at the respective stations of a flat panel display manufacturing line using a transferring system and then performing one or more manufacturing processes on the substrate at each of those locations.

A conventional flat panel display transferring system includes a “cassette,” a “stoker,” a “conveyor,” and an “indexer.” In the conventional system, the cassette, in which a plurality of substrates is loaded, is stored in the stoker, and the stoker with the stored cassettes is carried to the entrance of processing equipment using the conveyor. The indexer is then used to move the substrates in the cassette into and out of the processing equipment at the respective entrances of the processing stations.

However, conventional panel display conveying systems that use a cassette, stoker, conveyor, and indexer necessarily involve the presence of redundant in-process components, and can thus incur substantial costs in maintaining the redundant in-process components in the manufacturing line.

### BRIEF SUMMARY

In accordance with the exemplary embodiments described herein, the present invention overcomes the above problems by the provision of apparatus and methods for transferring flat panel displays within a flat panel display manufacturing line that minimizes both component transfer time and the number of in-process components present in the line.

According to one exemplary embodiment thereof, a flat panel display transferring system comprises a transfer device that transfers a container in which a substrate is loaded, and a container loading and unloading (“LU”) device that loads and unloads the container to and from the display processing equipment located at the respective processing stations of the line. The transfer device can include a fixed member, such as a track, mounted on floor of the facility and a plurality of moveable members, such as wheeled trucks, or carriages, that move along the fixed member.

The fixed member preferably includes a center track forming a closed loop and one or more looping branch tracks that branch out from the center track and are connected to the entrances of the respective display processing stations of the manufacturing line. In one exemplary embodiment, each of the center and branch tracks includes elongated rails and a plurality of coils disposed between the rails. For example, the tracks can comprise two parallel rails that are spaced apart from each other at a predetermined distance, with the plurality of coils being arranged at predetermined intervals along the length of the rails. Each of the rails preferably includes extensions that extend upwardly from the outer edges thereof.

The carriages include a container support bed, a permanent magnet mounted under the bed and disposed in a spaced apart, overlying relationship with the coils, and wheels mounted under the bed and adapted to engage and roll along the rails. Preferably, auxiliary wheels that contact the upstanding extensions of the rails are also included below the bed. The coils of the track and the permanent magnet of the carriages define a linear motor that controllably propels the carriages along the tracks.

The substrate transfer container includes a lattice-shaped base frame, a plurality of upstanding support frames mounted on the base frame, a plurality of first support pins mounted on the first support frame that support the substrate, and a container cover that covers the substrate. A base cover that closes the space between lattice beams of the base frame is also included. A side surface of the container cover is openable and closable, e.g., by means of a hinged closure, or door. The container can also include additional substrate support frames and pins mounted on top of each other for simultaneous transportation of a plurality substrates in a stacked fashion.

The container LU device includes an enclosure having an interior space and a vertical transfer device, or elevator, mounted in the enclosure. A fan unit having an air cleaning filter is mounted on the frame and arranged to blow filtered air into the enclosure to prevent the entrance of contaminants. The elevator operates to move the container in a vertical direction within the enclosure. The enclosure of the LU device includes an opening at a side surface thereof, the container LU device is mounted adjacent to each of the entrances of the processing stations, and a track of the system is laid out to pass through a lower side of the container LU device.

In one exemplary embodiment, a substrate loading and unloading (“LU”) robot is mounted between the container LU device and the respective entrances of each of the processing stations. The LU robot includes a support portion, a horizontal and vertical transfer portion mounted on the support portion, and a transfer arm mounted on the horizontal and vertical transfer portion. A substrate loaded on the transfer arm of the robot is transferred from the transfer container to the equipment of a processing station through the opening of the enclosure of the LU device, and the transfer arm of the robot is arranged to move between the LU device and the processing equipment by way of the shortest path.

In an alternative embodiment, a transfer conveyor is mounted between the LU device and the processing equipment, and a container conveyor is mounted in the transfer container such that the two conveyors are located in line with each other and at the same vertical level.

In accordance with an exemplary method of the present invention, a method of transferring a flat panel display includes positioning a carriage, which moves along a track and on which a transfer container is loaded, below a container LU device, raising the container with an elevator mounted in the container LU device, and transferring a display substrate contained in the container into the equipment located at a display processing station. When the substrate has been transferred into the processing equipment, the empty carriage moves away from the station along the track.

The method further includes lowering the transfer container with the elevator to load the container onto a second carriage, and moving the second carriage away from the station along the track.

The method can further include opening a side surface of the container, introducing the transfer arm of a LU robot located between the container device and the processing equipment into the transfer container through an opening of the container LU device, loading the substrate onto the transfer arm, moving the transfer arm into the processing station, and placing the substrate in the processing equipment of the station.

In an alternative embodiment of the method, the transfer container can include a container conveyer upon which the substrate is loaded, and transferring of the substrate contained in the container can include opening a side surface of the transfer container, positioning a transfer conveyor mounted between the container LU device and the processing equipment and positioned in line with and at the same vertical level as the container conveyer, and simultaneously driving the transfer conveyor and the container conveyor, thereby carrying the substrate loaded on the container conveyor into the equipment of a processing.

According to another aspect of the present invention, a method is provided for transferring a flat panel display between the processing stations of a manufacturing line, including positioning a first moveable member that moves along a fixed member and on which a transfer container is loaded below a container LU device, and transferring a substrate contained in the transfer container into the equipment of a processing station by a substrate LU robot located between the container LU device and the station.

The transferring of the substrate contained in the transfer container can include opening a side surface of the transfer container, introducing a transfer arm of a substrate LU robot located between the container LU device and the processing station into the transfer container through an opening of the container LU device, loading the substrate onto the transfer arm, moving the transfer arm into the processing station, and placing the substrate in the processing equipment of the station.

In an alternative embodiment of the method, the transferring of the substrate contained in the transfer container may include opening a side surface of the transfer container, simultaneously driving a transfer conveyor mounted between the container LU device and the processing equipment and a container conveyor mounted in the transfer container, and carrying the substrate loaded on the container conveyor into the processing equipment. Preferably, the transfer conveyor and the container conveyor are located in line with each other and at the same vertical level.

A better understanding of the above and many other features and advantages of the panel display substrate transfer system of the present invention may be obtained from the detailed description of the exemplary embodiments thereof below, particularly if such consideration is made in conjunction with the several views of the appended drawings, wherein like reference numerals are used to identify like elements illustrated in one or more of the figures thereof.

### BRIEF DESCRIPTION OF THE DRAWINGS

FIG. 1 is an upper side schematic perspective view of a first exemplary embodiment of a system for transferring flat panel display substrates between the processing stations of a display manufacturing line in accordance with the present invention;

FIGS. 2A, 2B and 2C are top plan, cross-sectional elevation, and upper side perspective views, respectively, of a transfer device of the system of FIG. 1;

FIG. 3 is an upper side perspective view of a transfer container of the system of FIG 1;

FIG. 4 is an upper side perspective view of a container loading and unloading device of the system of FIG. 1;

FIGS. 5-8 are cross-sectional elevation views sequentially illustrating the loading and unloading of a substrate to and from a processing station using the container loading and unloading device and a transfer robot of the system of FIG. 1;

FIG. 9 is a cross-sectional elevation view of a second exemplary embodiment of a flat panel display substrate transferring system in accordance with the present invention, illustrating the loading and unloading of a substrate to and from a display processing station using a container loading and unloading device and a transfer robot thereof; and,

FIGS. 10 and 11 are cross-sectional elevation views of a third exemplary embodiment of a flat panel display substrate transferring system in accordance with the present invention, sequentially illustrating the loading and unloading of a substrate to and from a display processing station using a container loading and unloading device and a pair of inline conveyors thereof.

### DETAILED DESCRIPTION

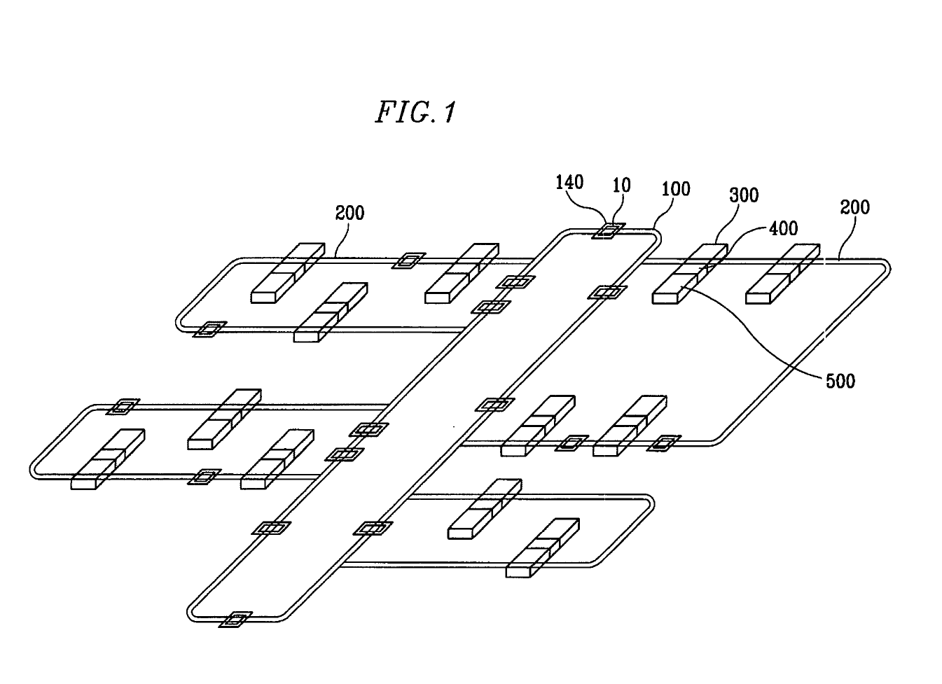

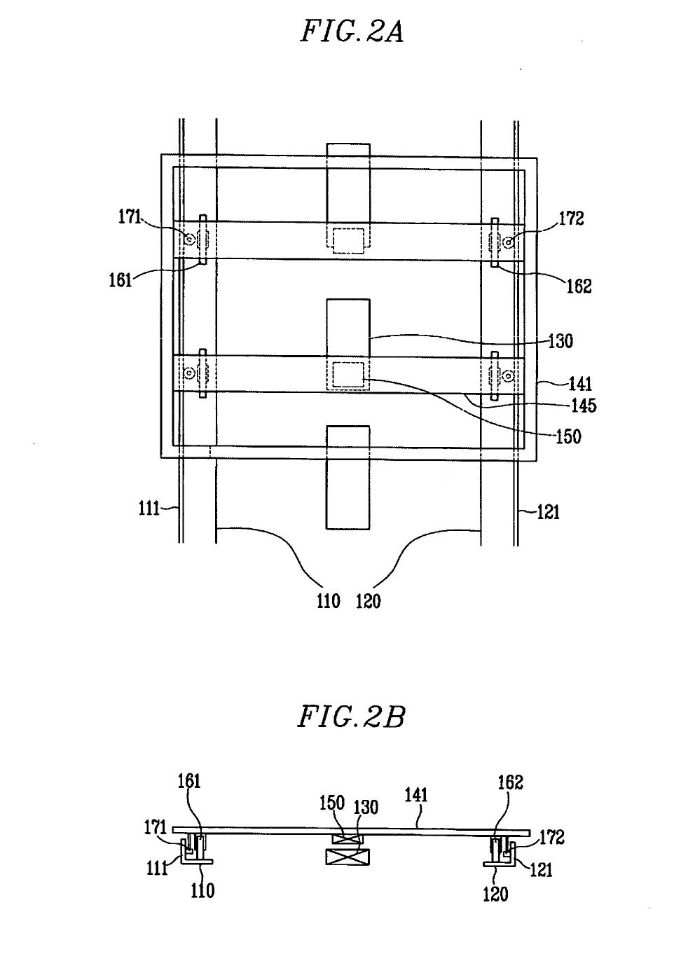

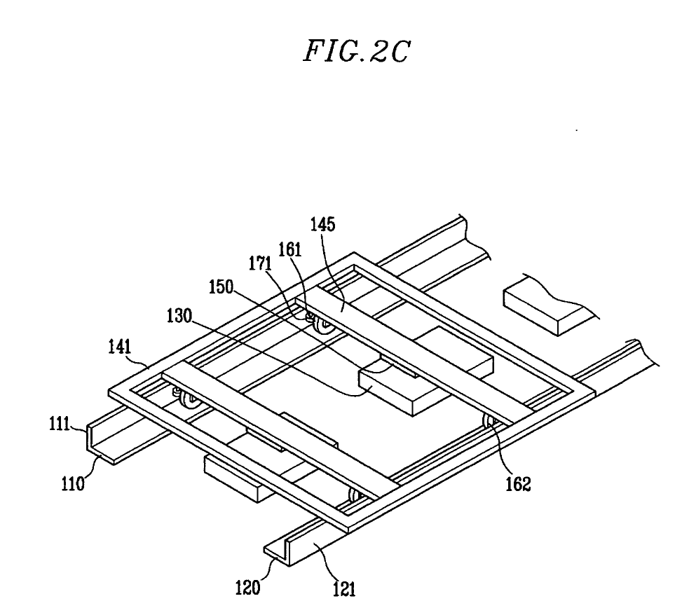

FIG. 1 schematically illustrates a first exemplary embodiment of a system for transferring the substrates of flat panel displays between the processing stations of a display manufacturing line in accordance with the present invention. FIGS. 2A, 2B and 2C are top plan, cross-sectional elevation, and upper side perspective views, respectively, of a transfer device of the system of FIG. 1.

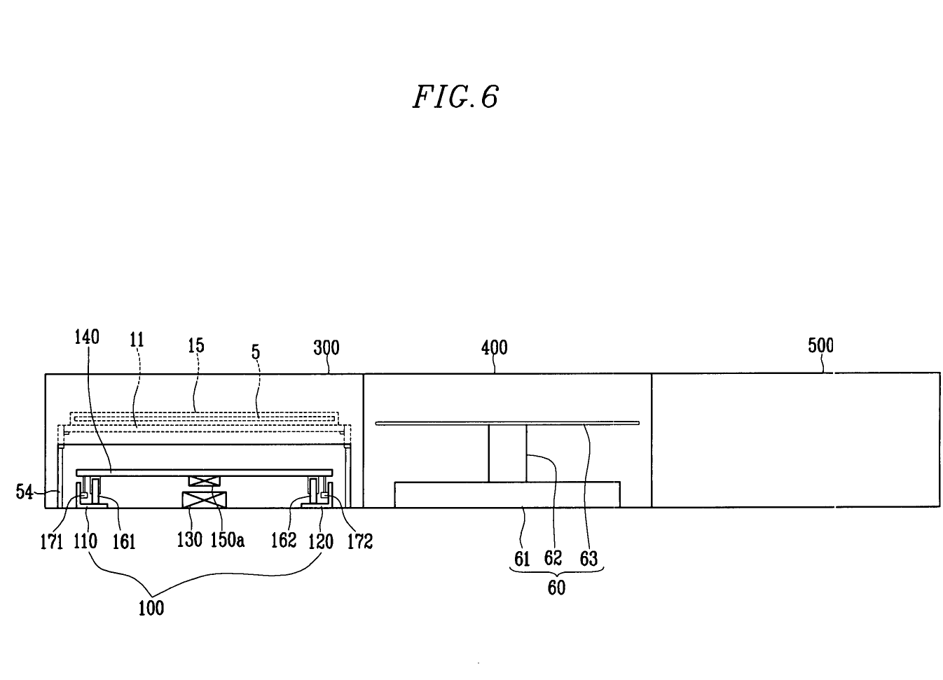

As illustrated in FIGS. 1-2C, the panel transferring system includes transfer devices 100, 140, and 200 for transferring a transfer container 10 in which a display substrate 5 (see FIG. 5) is loaded between the processing stations of the line, and a container loading and unloading (“LU”) device 300 for loading and unloading of the transfer container 10 to and from the equipment located at the respective stations 500. A connection device 400 is provided between the processing stations 500 and the container LU device 300. In the exemplary embodiment illustrated in FIGS. 1-2C, a substrate loading and unloading (“LU”) robot 60 is mounted in the connection device 400.

The transfer devices 100, 140, and 200 comprise tracks 100 and 200 mounted on the floor of the production facility, and a plurality of carriages 140 that move along the tracks 100 and 200 between the processing stations 500. As illustrated in FIG. 1, the tracks 100 and 200 include a center track 100 forming a closed loop, and one or more looping branch tracks 200 that branch out from the center track 100 and are connected to the entrances of the respective processing stations 500. As illustrated in FIG. 2A and 2B, each of the center track 100 and the branch tracks 200 includes a pair of elongated rails 110 and 120, and a plurality of coils 130 disposed between the rails at spaced intervals along their length. The rails 110 and 120 are parallel with and spaced apart from each other at a selected distance, and have extensions 111 and 121 which extend upwardly from the outer edges of the rails 110 and 120.

Each of carriages 140 includes a horizontal support bed 141, a permanent magnet 150 mounted below the bed in a spaced apart, overlying relationship with the coils 130, and wheels 161 and 162 respectively mounted on opposite sides of and below the bed and arranged to engage and roll along the rails. In the particular exemplary embodiment illustrated, the bed includes a pair of horizontal slats 145, which help support the bed and prevent it from being warped or wracked by heavy loads.

As illustrated in FIGS. 2A and 2B, the support bed 141 of the carriage 140 also includes auxiliary wheels 171 and 172, which are mounted below the support bed 141 to contact the respective upright extensions 111 and 121 of the rails 110 and 120. The auxiliary wheels 171 and 172 apply a force toward the respective extensions 111 and 121 of the rails 110 and 120 such that lateral movement and yawing of the carriage 140 on the rails is resisted, thereby preventing the carriage from being easily derailed from the tracks 100 and 200 during operation.

As those of skill in the art will appreciate, the permanent magnet 150 of the carriage 140 and the coils 130 of the tracks 100 and 200 define a linear motor that is capable of moving the carriage along the tracks stably, at a relatively high speed of about 200 m/minute. Thus, the carriages 140 do not need to be connected with a power supply unit, and further, do not require any mechanical element for the delivery of motive power. Accordingly, the carriages can be light in weight and programmed to move rapidly and with precision to any position along the tracks 100 and 200.

The center track 100 and the branch tracks 200 stably guide the carriages 140 in a predetermined path such that the carriages 140 cannot separate from the tracks during movement along either straight or curved portions thereof, and further, the carriages 140 can efficiently and stably change their direction of travel at junctions between the center and branch tracks 100 and 200.

In a preferred embodiment, the tracks 100 and 200 are connected to a communication device, such as a serial communication device or a field bus, such that operational information, including speed and position of the carriages 140, can be monitored and controlled by a computer. Additionally, an interlocking device can be provided to prevent collisions between the carriages 140 during operation of the system. Addition fail-safe devices can be provided in the system such that a malfunction of one carriage 140 or the driving coil 130 associated with it can stop driving of the other carriages 140 and/or associated driver coils 130.

It should be further understood that, in the case of a conventional panel display transfer system of the type that uses a stoker, when the stoker malfunctions, the entire manufacturing process must be halted. However, in the transfer system of the present invention, if one carriage 140 is out of order, movement of the other carriages 140 within the system can be quickly resumed simply by removing only the malfunctioning carriage 140 from the system.

Further, since the tracks 100 and 200 of the system can be easily laid, maintained and even waterproofed, if desired, the transfer system can be readily deployed in a processing line that uses moisture-aversive chemical agents, such as a cleaning line.

Additionally, it may be seen that an increase in production capacity is readily obtainable simply by increasing the number of carriages 140, and moreover, the travel path of the carriages 140 can be more rapidly and easily expanded as compared with a conventional conveyor system.

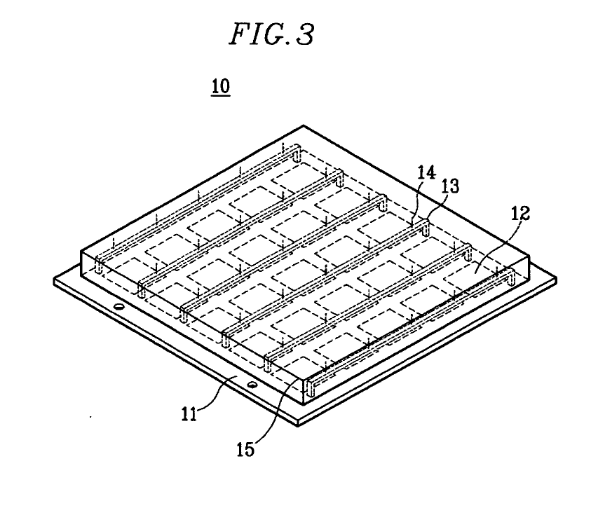

FIG. 3 is an upper side perspective view of a transfer container 10 of the first embodiment of the flat panel display transferring system of the present invention. As illustrated in FIG. 3, the transfer container 10 includes a lattice-shaped base frame 11, a plurality of support frames 13 mounted on the base frame 11, first support pins 14 mounted on the support frame 13 and supporting a display substrate 5, and a protective container cover 15 that covers the substrate 5.

The base frame 11 of the container 10 is provided with a lattice shape such that it is light in weight but strong so as to prevent it from being warped or wracked by the weight of a large substrate 5. Base plugs, or covers 12, are mounted in the openings between the lattice beams to prevent foreign material from entering the container through the openings.

The first support pins 14 are mounted as a group and are spaced apart from each other at a selected intervals. Accordingly, an arm of a substrate loading and unloading (“LU”) robot 60 of the type described below can enter into the spaces between the first support pins 14, lift up a substrate 5 supported on the pins, and carry it out of the transfer container 10.

Additional support frames and support pins (not illustrated) can be mounted above the first support frame 13 and pins 14 at selected vertical intervals, to support additional substrates 5 in the container in a stacked fashion. Thus, it should be understood that, although the particular transfer container 10 illustrated in the figures is shown as carrying only one substrate 5, the container is can easily be configured to carry a plurality of substrates simultaneously. Preferably, the side surface of the container cover 15 is openable and closed by way of a hinged closure to prevent contamination of the substrates by foreign matter during transit. Accordingly, when the closure of the side surface of the container cover 15 is opened, the substrate LU robot 60 can either carry a substrate 5 out of the transfer container 10 or transfer a substrate from the processing station 500 into the container. Alternatively, the upper surface of the container cover 15 can incorporate a closure (not illustrated) that opens to enable the substrate LU robot 60 to carry the substrate 5 from the transfer container 10 to the processing equipment 500.

In the exemplary embodiment illustrated, the base frame 11 of the transfer container 10 is made of an aluminum (Al) alloy or carbon fiber reinforced plastic (CFRP), the base cover(s) 12 and the container cover 15 are made of polycarbonate, and the first support frame 13 and the first support pins 14 are made of carbon fiber reinforced plastics. Accordingly, the resulting transfer container 10 is both light in weight, strong and rigid, is easily maintained, and is difficult to deform. Since the transfer container 10 in which the substrate 5 is loaded moves to the respective processing stations 500 by way of the carriages 140, the container can either transfer or store the substrate 5 while maintaining the high level of cleanliness required of a flat panel display manufacturing facility. Furthermore, the transfer container 10 can prevent the substrate 5 from being scratched or damaged when it is being transferred.

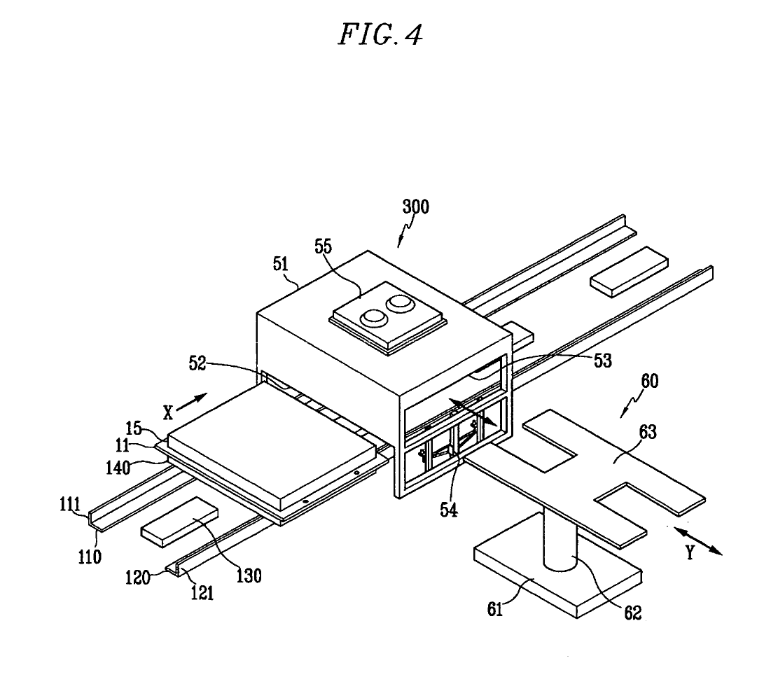

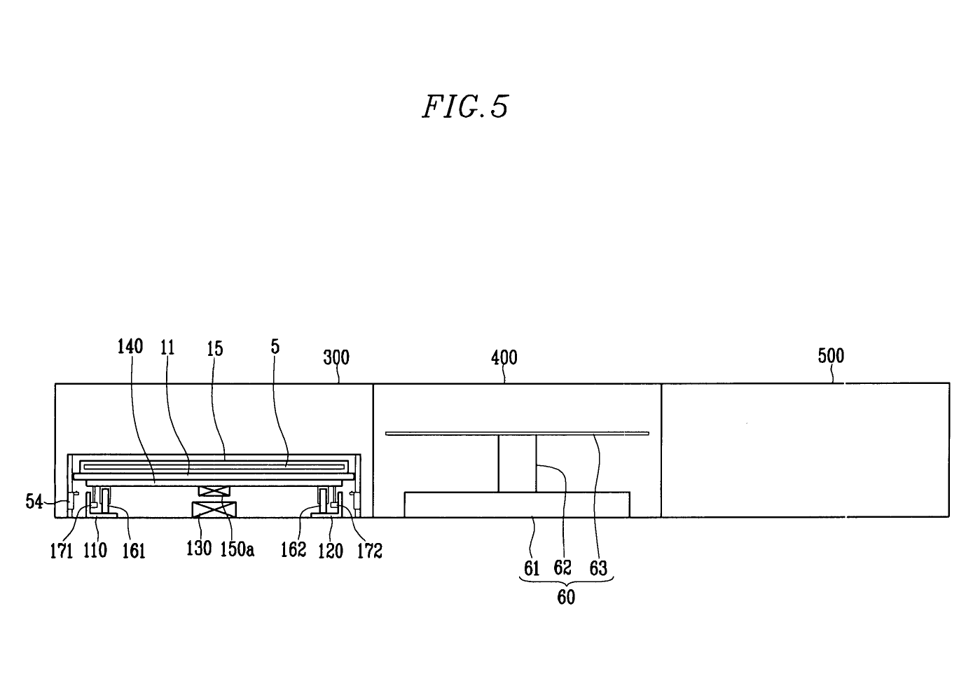

FIG. 4 is an upper side perspective view of the container loading and unloading (“LU”) device 300 of the exemplary first embodiment of the flat panel display transferring system. As illustrated in FIG. 4, the container LU device 300 is mounted adjacent to the entrance of a display processing station 500 (see FIG. 5), and the rails and driving coils 110, 120, and 130 of the tracks pass through the lower side of the container LU device 300. The container LU device 300 includes a rectangular enclosure 51 enclosing an internal space in which a vertical transfer device, i.e., an elevator 54, is mounted. The enclosure 51 has openings 52 at its front and rear lower surfaces and openings 53 at its side surfaces. The rails and driving coils 110, 120, and 130 of the tracks pass through the front and rear openings 52 of the enclosure 51.

The elevator 54 is mounted outside of the rails 110 and 120 that pass through the enclosure 51, and is adapted to raise a transfer container 10 up from or lower it down onto a carriage 140 disposed on the rails, i.e., to transfer the transfer container 10 in a vertical direction relative to the rails and the carriage 140.

As illustrated in FIG. 4, a substrate LU robot 60 is arranged to unload a substrate 5 directly from the transfer container 10 to the processing equipment 500. The substrate LU robot 60 is mounted between the container LU device 300 and the entrance of the substrate processing station 500 (see FIG. 5), and includes a support portion 61, a horizontal and vertical (“HV”) transfer portion 62 mounted on the support portion 61, and a transfer arm 63 mounted on the HV transfer portion 62. The HV transfer portion 62 moves the transfer arm 63 in a Y or Z direction, and the transfer arm 63 moves between the container LU device 300 and the entrance to the equipment of the processing station 500 by a straight-line, i.e., the shortest path, thereby minimizing substrate transfer time. Thus, during the loading or unloading of a substrate 5, the substrate LU robot 60 is not required to rotate about a Z-axis, and the transfer arm 63 is required to move only in the XY plane.

In addition, unlike a substrate LU robot 60 used in a conventional transfer system that includes a stoker, since the substrate LU robot 60 of the present embodiment needs to move only a small amount in the Z direction to be able to lift and place the substrate 5, the amount of movement of the substrate 5 in the Z direction is relatively much smaller, and hence, the time required to load or unload the substrate 5 is relatively shorter.

In operation, the transfer arm 63 of the substrate LU robot 60 enters into the transfer container 10 through the opening 53 in the side of the enclosure 51, loads the substrate 5 thereon, then translates to the entrance of the processing station 500 and thereby carries the substrate 5 into the processing equipment located therein.

As illustrated in FIG. 4, a fan unit 55 with an air filter is mounted on the enclosure 51 of the container LU device 300 and arranged to blow clean air downward into the enclosure 51. As a result, contaminated air is prevented from entering into the transfer container 10, and thus, dust is prevented from attaching to the substrate 5 when opening and closing the transfer container 10. Thus, the cleanliness required in the flat panel display manufacturing facility can be maintained even during container loading and unloading.

FIGS. 5 to 8 sequentially illustrate a method of loading or unloading a panel display substrate 5 to or from a substrate processing station 500 using the container LU device 300 and the substrate LU robot 60 of the first exemplary embodiment of the system of the present invention.

As illustrated in FIG. 5, a carrier 140 is first loaded with a transfer container 10 containing one or more display substrates 5 and then propelled along the rails 110 and 120 of the tracks by the linear motor elements 130 and 150a to a position directly below the container LU device 300, which is mounted adjacent to the entrance of a target processing station 500, with a transfer device 400 incorporating a substrate LU robot 60 disposed therebetween.

Next, as illustrated in FIG. 6, the transfer container 10 is raised by the elevator 54 of the container LU device 300 to a level that is slightly higher than the upper surface of the arm 63 of the substrate LU robot 60.

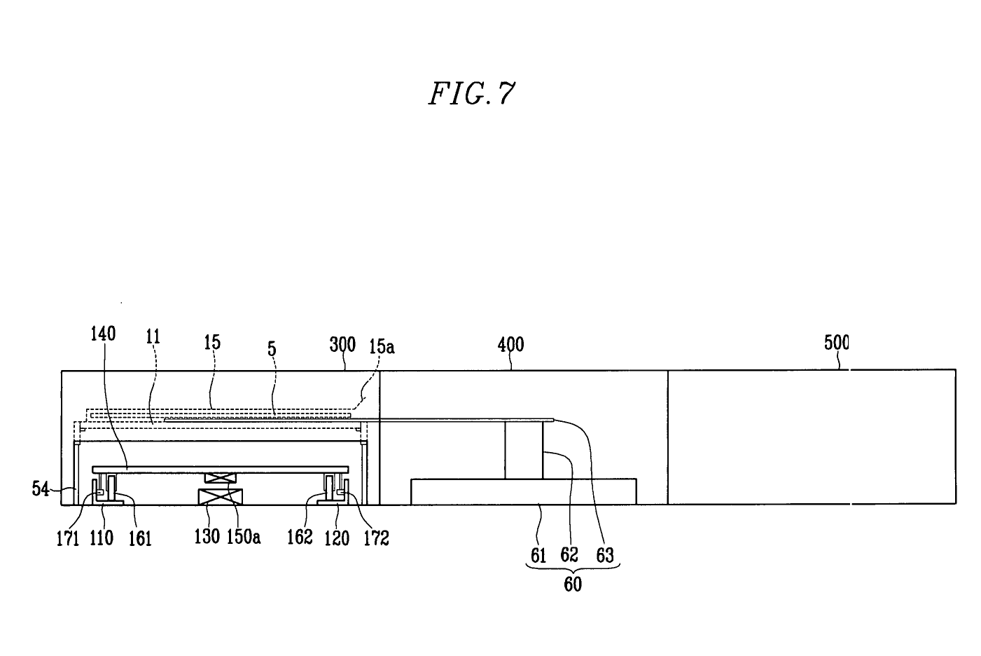

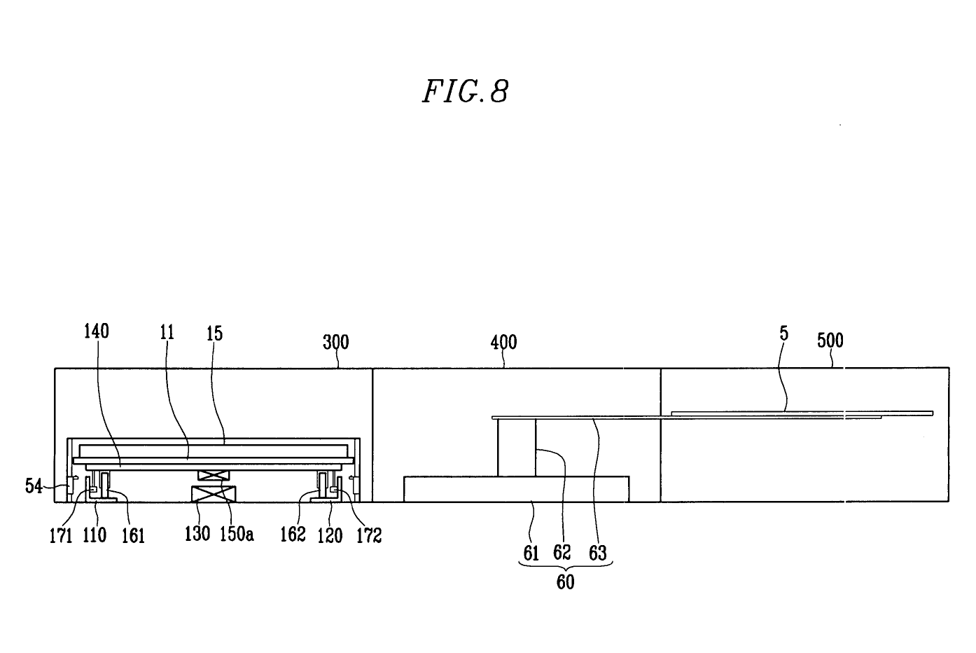

Then, as illustrated sequentially in FIGS. 7 and 8, the transfer arm 63 of the substrate LU robot 60 enters into the transfer container 10, lifts the substrate 5 up from the support pins of the container, and translates it into the entrance of the processing station 500. That is, as illustrated in FIG. 7, the hinged side surface 15a closure, or door, of the transfer container 10 is opened, and the transfer arm 63 of the substrate LU robot 60 enters through the side opening 53 of the container LU device 300 and into the transfer container 10, as described above. The substrate 5 is then loaded onto the transfer arm 63, and as illustrated in FIG. 8, the transfer arm 63 then moves into the processing station 500 and places the substrate 5 therein.

When the substrate 5 is placed in the processing station 500, the empty carriage 140 can then depart by way of the rails 110, 120 of the tracks 100, 200 to a next destination thereon. A second empty carriage 140 can then be moved along the tracks and positioned below the container LU device 300. The empty transfer container 10 is then lowered by the elevator 54 and loaded onto the second carriage. The second carriage 140 can then depart, carrying the empty transfer container 10 to a next destination along the tracks.

As will be appreciated, when it is desired to move a processed substrate 5 from a processing station 500 to another destination, e.g., a second processing station 500 in the manufacturing line, the foregoing procedure is simply effected in the reverse order.

Since the carriages 140 can move continuously and independently of each other along the rails 110, 120 except when a transfer container 10 is being loaded or unloaded to or from them, transfer delays do not occur in the system and substrate transfer time is substantially reduced.

Furthermore, since a plurality of substrates 5 can be transferred simultaneously using the same transfer container 10 and linear motor system, the number of in-process components can be significantly reduced. In addition, the cumulative substrate transfer time is substantially reduced by the more direct connection between the manufacturing process stations afforded by the system.

As will be appreciated, in a factory manufacturing line, the in-process components are those that are being manufactured on the line at a given point in time. In general, since the same components are being successively processed in the factory, the in-process components exist in each stage of processing. Accordingly, the amount of the in-process components in each processing stage is generally calculated as inventory. In the system of the present invention, since the substrates 5 are successively transferred without the use of a conventional stoker, the transfer system operates without interruption or the need to provide redundant in-process components, and thus, the number of in-process components, i.e., excess inventory, is reduced.

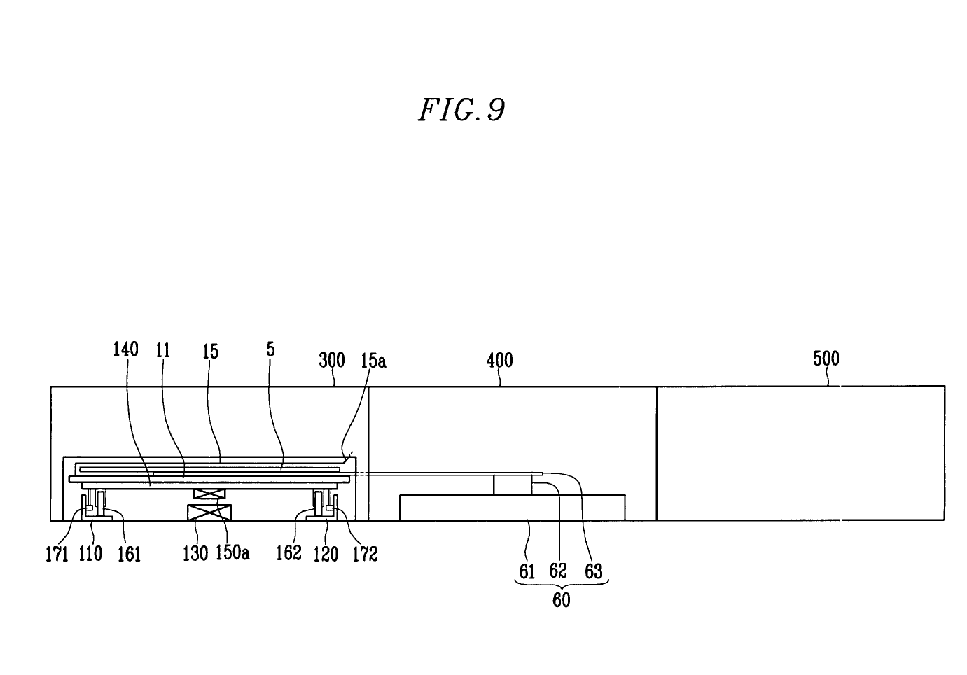

A second exemplary embodiment of a system for transferring flat panel displays between the processing stations of a panel display manufacturing line in accordance with the present invention is illustrated in the schematic cross-sectional elevation view FIG. 9, wherein like reference numerals are used to identify elements that are the same or similar to those of the first embodiment described above.

As illustrated in FIG. 9, a carriage 140 loaded with a transfer container 10 containing a display substrate 5 is propelled along the rails 110, 120 of a track by the linear motor 130, 150a and then positioned directly below a container LU device 300 disposed adjacent to the entrance of a target display processing station 500, with a transfer device 400 incorporating a substrate LU robot 60 disposed therebetween. Next, the substrate 5 in the transfer container 10 is carried directly into the processing equipment of the station 500 by the substrate LU robot 60. That is, the hinged closure 15a in the side surface of the cover 15 of the transfer container 10 is first opened. The transfer arm 63 of the substrate LU robot 60 then enters into the transfer container 10 through the opening 53 of the container LU device 300, and the substrate 5 is loaded onto the transfer arm 63. The transfer arm 63 then moves into the equipment of the processing station 500 and places the substrate 5 therein.

As may be seen by a comparison of FIGS. 5 and 9, the second embodiment differs from the first embodiment in that the substrate LU robot 60 transfers the substrate 5 contained in the transfer container 10 into the processing equipment 500 directly without raising the transfer container 10 off of the carriage 140. That is, since the substrate 5 is initially disposed in the container 10 on the carriage 140 at a level slightly above that of the arm 63 of the substrate LU robot 60, the step of raising the container 10 with an elevator 54 disposed in the container LU device 300 is unnecessary, and accordingly, the latter feature is eliminated from the second exemplary embodiment.

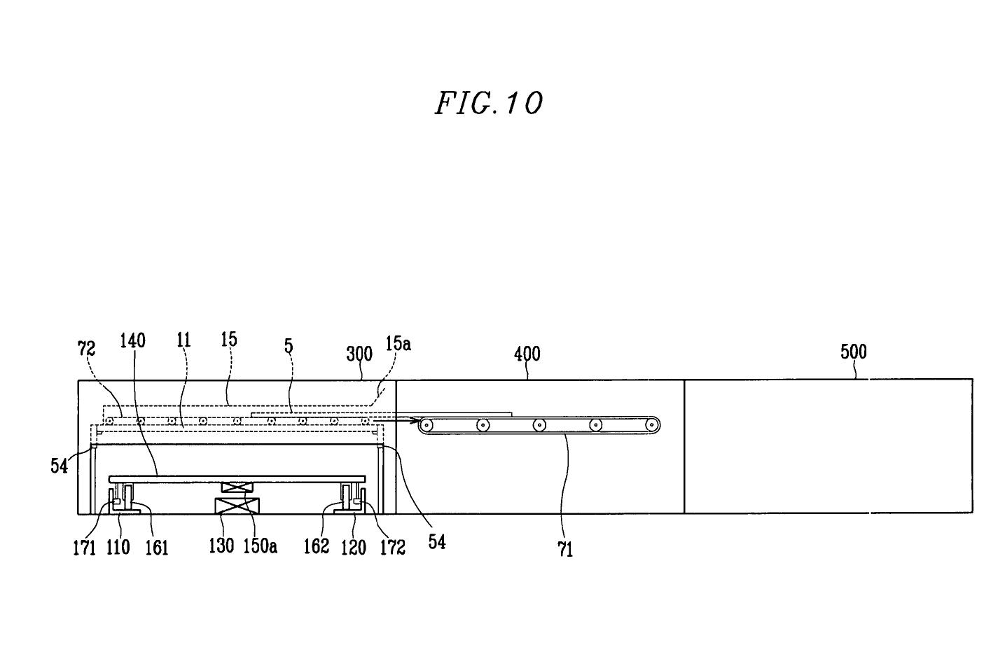

A third exemplary embodiment of a system for transferring flat panel display substrates between the processing stations of a panel display manufacturing line in accordance with the present invention is illustrated in the schematic cross-sectional elevation view FIG. 10, wherein like reference numerals are used to identify elements that are the same as or similar to those of the first and second embodiments described above.

The third embodiment of FIG. 10 differs from the first and second embodiments above in that, instead of a substrate LU robot 60, a transfer conveyor 71 is mounted between the container LU device 300 and the processing station 500, and in the particular embodiment illustrated in FIG. 10, a second, container conveyor 72 is also mounted within the transfer container 10.

In a method of transferring flat panel displays using the transfer system of FIG. 10, a carriage 140 carrying a transfer container 10 having a container conveyor 72 with a substrate 5 loaded thereo is propelled along the rails 110, 120 of a track by the linear motor 130, 150a and positioned directly below the container LU device 300 mounted at the entrance of a target processing station 500, as in the above embodiments.

When positioned in the container LU device 300, the transfer container 10 is raised by the elevator 54, and the substrate 5 contained in the transfer container 10 is then transferred into the equipment of the processing station 500 by the transfer conveyor 71. That is, the hinged closure 15a in the side surface of the transfer container 10 is first opened. The transfer conveyor 71 mounted between the container LU device 300 and the processing station 500 and the container conveyor 72 mounted in the transfer container 10 are positioned in line with each other and at the same vertical level. The transfer conveyor 71 and the container conveyor 72 are simultaneously driven and the substrate 5 is thereby carried from the container conveyor 72 to the transfer conveyor 71, which then carries the substrate into the processing station 500.

When the substrate 5 contained in the transfer container 10 is transferred into the processing station 500, the empty carriage 140 moves away to a next destination along the tracks.

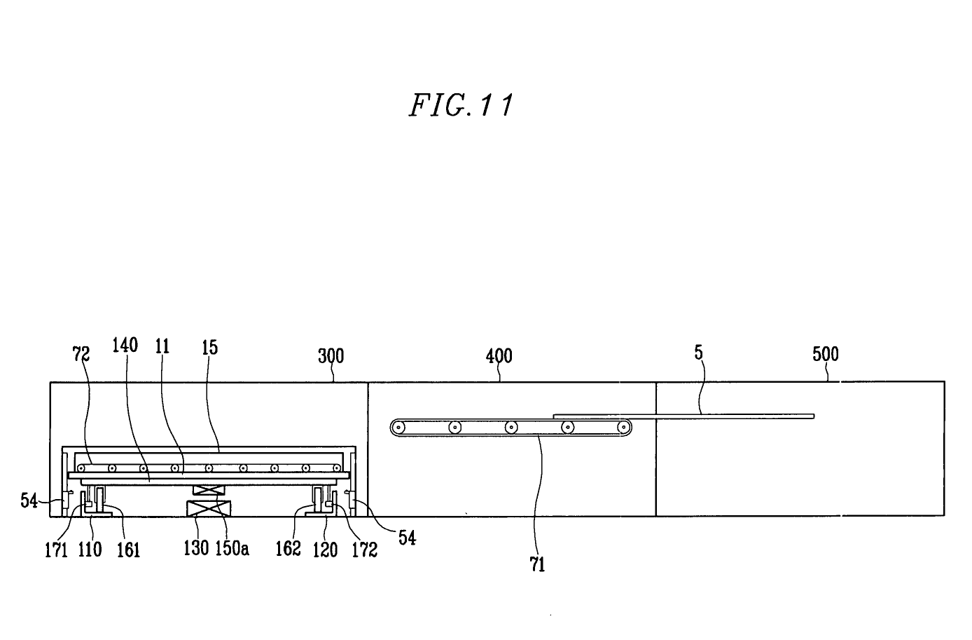

Next, as illustrated in FIG. 11, a second empty carriage 140 is moved along the rails 110, 120 and positioned below the container LU device 300. The empty transfer container 10 is then lowered by the elevator 54 and loaded onto the second carriage, which then moves away to a programmed next destination along the tracks.

According to the present invention, since a transfer device and a container LU device driven by a linear motor are used, the time to transfer a substrate between processing stations can be reduced substantially. Furthermore, since the substrates are transferred in protective transfer containers, the substrates are transferred more cleanly and safely.

Furthermore, since the substrates are transferred using a plurality of transfer containers, rather than with a stoker and a cassette, the number of transfers required is minimized, and the number of in-process components in the system, and hence, in-process inventory, is reduced.

In addition, a track system that incorporates a linear motor system is one that is easily set up and maintained, and a transfer system using the same can be flexibly embodied in accordance with the needs of the production processing, and production capacity is thus easily expanded.

Moreover, even if specific manufacturing processing equipment is out of order, the other processing equipment is not affected and thus processing flexibility can be ensured.

In addition, since a conventional cassette, stoker, conveyor, and indexer are not used, the initial investment cost of the processing equipment can be significantly reduced, and since the substrates are managed and transferred entirely within the transfer container, the number of in-process components can be significantly reduced at each stage of processing.

By now, those of skill in this art will appreciate that many modifications, substitutions and variations can be made in and to the materials, apparatus, configurations and methods of the substrate transferring system of the present invention without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalents.

What is claimed is:

1. A system for transferring a flat panel display between the processing stations of a display manufacturing line, comprising:
a transfer device which transfers a transfer container in which a substrate is loaded; and,
a container loading and unloading (LU) device that loads and unloads the transfer container to and from equipment located at the processing stations,
wherein the transfer device includes a fixed member mounted on a facility floor and a plurality of moveable members which move along the fixed member.

2. The system of claim 1, wherein the fixed member includes a center track forming a closed loop and one or more looping branch tracks that branch out from the center track and are connected to entrances of the processing stations.

3. The system of claim 1, wherein each of the center track and the branch tracks includes a plurality of elongated rails and a plurality of coils disposed between the rails.

4. The system of claim 3, wherein the number of the rails is two, and the two rails are disposed parallel to each other and spaced apart by a selected distance.

5. The system of claim 3, wherein the rails include upright extensions at the outer edges thereof.

6. The system of claim 3, wherein the plurality of coils are arranged at selected intervals along the length of the rails.

7. The system of claim 1, wherein the moveable member comprises a wheeled carriage, including:
a transfer bed;
a permanent magnet mounted under the bed and disposed in an spaced, overlying relationship with the coils between the rails; and,
a plurality of wheels mounted below the bed and arranged to roll on the rails.

8. The system of claim 7, further comprising auxiliary wheels mounted below the bed and arranged to contact the upright extensions of the rails laterally and with a rolling engagement.

9. The system of claim 7, wherein the coils of the fixed member and the permanent magnet of the movement member define a linear motor.

10. The system of claim 1, wherein the transfer container includes:
a lattice-shaped base frame;
a plurality of support frames mounted on the base frame;
a first support pin mounted on the first support frame and supporting the substrate; and,
a container cover covering the substrate.

11. The system of claim 10, further comprising a base cover covering the space between lattice beams of the base frame.

12. The system of claim 10, wherein a side surface of the container cover includes a hinged closure that can be selectably opened and closed.

13. The system of claim 10, further comprising at least one second support frame and at least one second support pin mounted on the first support pin.

14. The system of claim 1, wherein the container LU device includes:
an enclosure forming an interior space; and,
an elevator mounted in the interior space of the enclosure.

15. The system of claim 14, further comprising a fan unit having an air cleaning filter mounted on the enclosure and arranged to blow clean, filtered air into the interior space thereof.

16. The system of claim 14, wherein the elevator is arranged to raise and lower the transfer container in a vertical direction.

17. The system of claim 14, wherein the enclosure includes an opening at a side surface thereof.

18. The system of claim 14, wherein the container LU device is mounted adjacent to an entrance of a processing station.

19. The system of claim 14, wherein the fixed member passes through a lower side of the container LU device.

20. The system of claim 14, wherein a substrate loading and unloading (LU) robot is mounted between the container LU device and the entrance of a processing station.

21. The system of claim 20, wherein the substrate LU robot includes a support portion, a horizontal and vertical (HV) transfer portion mounted on the support portion, and a transfer arm mounted on the HV transfer portion.

22. The system of claim 21, wherein a substrate loaded on the transfer arm of the substrate LU robot is transferred from the transfer container to the equipment of the processing station through an opening at a side surface of the enclosure.

23. The system of claim 21, wherein the transfer arm moves between the container LU device and the processing station by a path of shortest length.

24. The system of claim 14, wherein a transfer conveyor is mounted between the container LU device and the entrance of a processing station.

25. The system of claim 24, wherein a container conveyor is mounted in the transfer container.

26. A method of transferring a flat panel display, the method comprising:
propelling a first carriage having a transfer container loaded thereon along a track until the carriage is positioned below a container loading and unloading (LU) device;
raising the transfer container with an elevator mounted in the container LU device;
transferring a substrate contained in the transfer container to a substrate processing station adjacent to the container LU device; and,
moving the first carriage along the track after the substrate contained in the transfer container has been transferred to the processing station.

27. The method of claim 26, further comprising:
positioning a second carriage below the container LU device;
lowering the transfer container with the elevator until the container is loaded onto the second carriage; and,
propelling the second carriage on which the transfer container is loaded along the track.

28. The method of claim 26, wherein the transferring of the substrate contained in the transfer container includes:
opening a side surface of the transfer container;
introducing a transfer arm of a substrate loading and unloading (LU) robot located between the container LU device and the processing equipment into the transfer container through an opening of the container LU device;
loading the substrate onto the transfer arm; and,
moving the transfer arm into the processing station; and,
placing the substrate in the processing equipment of the station.

29. The method of claim 26, wherein the transferring of the substrate contained in the transfer container includes:
opening a side surface of the transfer container;
providing a transfer conveyor mounted between the container LU device and the processing station and a container conveyor mounted in the transfer container, the substrate being loaded on the container conveyor and the two conveyors being located in line with each other and at the same vertical level; and,
simultaneously driving the transfer conveyor and the container conveyor to thereby carry the substrate loaded on the container conveyor into the processing station.

30. A method of transferring a flat panel display, the method comprising:
propelling a first carriage on which a transfer container is loaded along a track until it is positioned below a container loading and unloading (LU) device; and,
transferring a substrate contained in the transfer container into a substrate processing station with a substrate loading and unloading (LU) device,
wherein the substrate LU device is located between the container LU device and an entrance of the processing station.

31. The method of claim 30, wherein the transferring of the substrate contained in the transfer container includes:
opening a side surface of the transfer container;
introducing a transfer arm of a substrate LU robot into the transfer container through an opening of the container LU device;
loading the substrate onto the transfer arm;
moving the transfer arm into the processing station; and,
placing the substrate in the equipment of the processing station.

32. The method of claim 30, wherein the transfer container includes a container conveyor upon which the substrate is loaded, and wherein transferring of the substrate contained in the transfer container includes:
opening a side surface of the transfer container; and,
simultaneously driving a transfer conveyor mounted between the container LU device and the processing station and the container conveyor to thereby carry the substrate on the container conveyor into the processing station.

33. The method of claim 32, wherein the transfer conveyor and the container conveyor are located in line with each other and at the same vertical level.
